(19) United States
(12) Patent Application Publication
(10) Pub. No.: US 2024/0212657 A1
(43) Pub. Date: Jun. 27, 2024

(54) KEYBOARD DEVICE AND INTERLOCKING METHOD OF HAMMER

(71) Applicant: Roland Corporation, Shizuoka (JP)

(72) Inventors: Yukihide Takata, Shizuoka (JP); Mutsuo Sawada, Shizuoka (JP); Shiro Uno, Shizuoka (JP)

(73) Assignee: Roland Corporation, Shizuoka (JP)

(21) Appl. No.: 18/482,023

(22) Filed: Oct. 6, 2023

(30) Foreign Application Priority Data
Dec. 27, 2022 (JP) 2022-210205

(51) Int. Cl. G10H 1/34; G10C 3/18

(52) U.S. Cl. CPC G10H 1/346; G10C 3/18; G10H 2230/065

(57) ABSTRACT

A keyboard device includes a support member, a plurality of keys swingably supported by the support member and arranged side by side in a scale direction, and a hammer interlocked with swinging of each key. The hammer includes a receiving part recessed downward. Each key includes a protrusion protruding downward and inserted into the receiving part. An arc surface is formed on at least one of a bottom surface of the receiving part and a lower surface of the protrusion. When each key swings, the protrusion rotates about a center of a circle including the arc surface.

### CROSS-REFERENCE TO RELATED APPLICATIONS

This application claims the priority benefit of Japan Application No. 2022-210205, filed on Dec. 27, 2022. The entirety of the above-mentioned patent application is hereby incorporated by reference herein and made a part of this specification.

### BACKGROUND

### Technical Field

The disclosure relates to a keyboard device and an interlocking method of a hammer, particularly to a keyboard device and an interlocking method of a hammer, in which a good feeling of key depression can be given.

### Related Art

A keyboard device is known in which a hammer is interlocked with swinging of a key. For example, WO2021/124477 (Patent Document 1) describes a technology in which a shaft hole 13a of a white key 10 is rotatably engaged with a shaft 43 formed in a hammer 4. In this technology, since an opening 13b is formed on a lower surface of the shaft hole 13a of the white key 10, a lubricant such as grease applied to an engagement portion between the shaft 43 of the hammer 4 and the shaft hole 13a of the white key 10 tends to flow down from the opening 13b. When the lubricant flows down from the opening 13b, since rotational resistance in the engagement portion between the hammer 4 and the white key 10 increases, a poor feeling is felt at the time of key depression.

With respect to this, Japanese Patent Laid-Open No. 2022-070658 (Patent Document 2), for example, describes a technology in which a protrusion 20 of a white key 2a is slidably engaged with a receiving part 63 formed in a hammer 6. According to this technology, a lubricant applied to an engagement portion between the receiving part 63 and the protrusion 20 can be held by the receiving part 63. Thus, an increase in sliding resistance in an engagement portion between the hammer 6 and the white key 2a can be suppressed.

However, in the technology of Patent Document 2, as the key is depressed or released, the protrusion of the key slides back and forth with respect to the receiving part of the hammer. Thus, the lubricant applied to the receiving part may be pushed aside back and forth by sliding of the protrusion. Thus, the sliding resistance of the protrusion in the receiving part may increase, and a poor feeling may be felt at the time of key depression. That is, the technologies of Patent Documents 1 and 2 both have a problem that the feeling of key depression cannot be sufficiently improved.

### SUMMARY

A keyboard device of the disclosure includes: a support member; a plurality of keys, swingably supported by the support member and arranged side by side in a scale direction; and a hammer, interlocked with swinging of each of the keys. The hammer includes a receiving part that is recessed downward. Each of the keys includes a protrusion that protrudes downward and is inserted into the receiving part. An arc surface is formed on at least one of a bottom surface of the receiving part and a lower surface of the protrusion. When each of the keys swings, the protrusion rotates about a center of a circle including the arc surface.

An interlocking method of a hammer of the disclosure is adapted for a keyboard device, the keyboard device including: a support member; a plurality of keys, swingably supported by the support member and arranged side by side in a scale direction; and a hammer, interlocked with swinging of each of the keys. The hammer includes a receiving part that is recessed downward. Each of the keys includes a protrusion that protrudes downward and is inserted into the receiving part. An arc surface is formed on at least one of a bottom surface of the receiving part and a lower surface of the protrusion. In the interlocking method of a hammer, by rotating the protrusion about a center of a circle including the arc surface, the hammer is interlocked with swinging of each of the keys.

### BRIEF DESCRIPTION OF THE DRAWINGS

FIG. 1 is a perspective view of a keyboard device according to one embodiment.

FIG. 2 is a cross-sectional view of the keyboard device.

FIG. 3A is a partially enlarged cross-sectional view of the keyboard device in portion IIIa of FIG. 2; FIG. 3B is a partially enlarged cross-sectional view of the keyboard device, showing a state in which a white key is depressed from the state shown in FIG. 3A.

FIG. 4A is a partially enlarged cross-sectional view of the keyboard device, in which an engagement portion between a protrusion of the white key and a receiving part of a hammer is enlarged; FIG. 4B is a partially enlarged perspective view of the white key, in which portion IVb of FIG. 1 is enlarged.

FIG. 5A is a partially enlarged cross-sectional view of the keyboard device, showing a recess of a first modification; FIG. 5B is a partially enlarged cross-sectional view of the keyboard device, showing a recess of a second modification.

FIG. 6A is a partially enlarged cross-sectional view of the keyboard device, showing a receiving part of a modification; FIG. 6B is a partially enlarged cross-sectional view of the keyboard device, showing a state in which the white key is depressed from the state shown in FIG. 6A.

FIG. 7A is a partially enlarged cross-sectional view of the keyboard device, showing a protrusion of a modification; FIG. 7B is a partially enlarged cross-sectional view of the keyboard device, showing a state in which the white key is depressed from the state shown in FIG. 7A.

### DESCRIPTION OF THE EMBODIMENTS

The disclosure provides a keyboard device and an interlocking method of a hammer, in which a feeling of key depression can be improved.

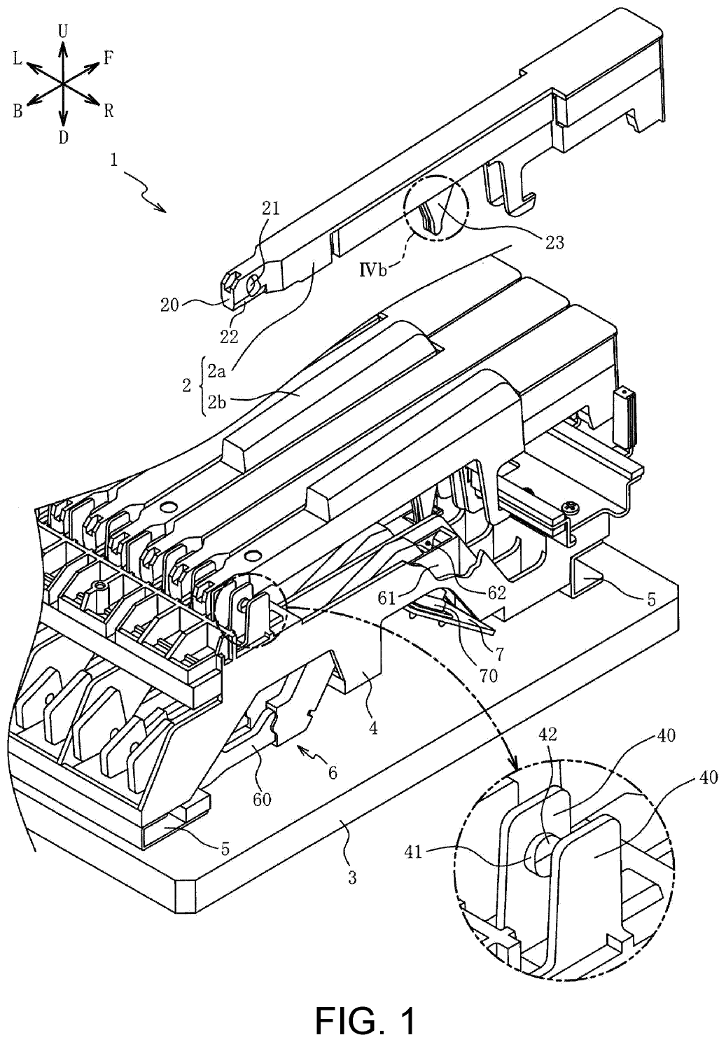

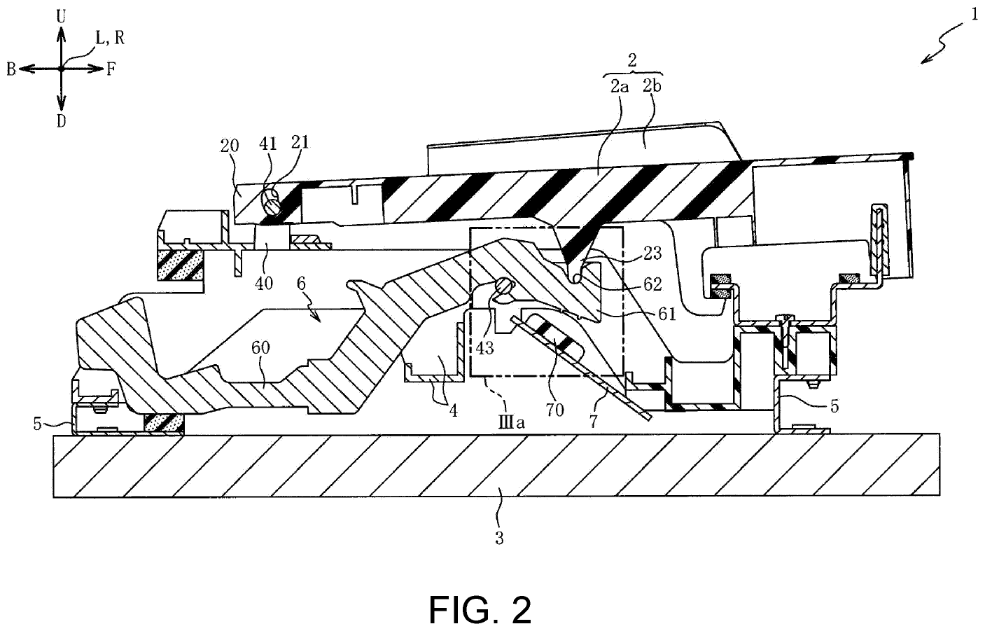

Hereinafter, an embodiment is described with reference to the accompanying drawings. First, an overall configuration of a keyboard device 1 is described with reference to FIG. 1 and FIG. 2. FIG. 1 is a perspective view of the keyboard device 1 according to one embodiment. FIG. 2 is a cross-sectional view of the keyboard device 1.

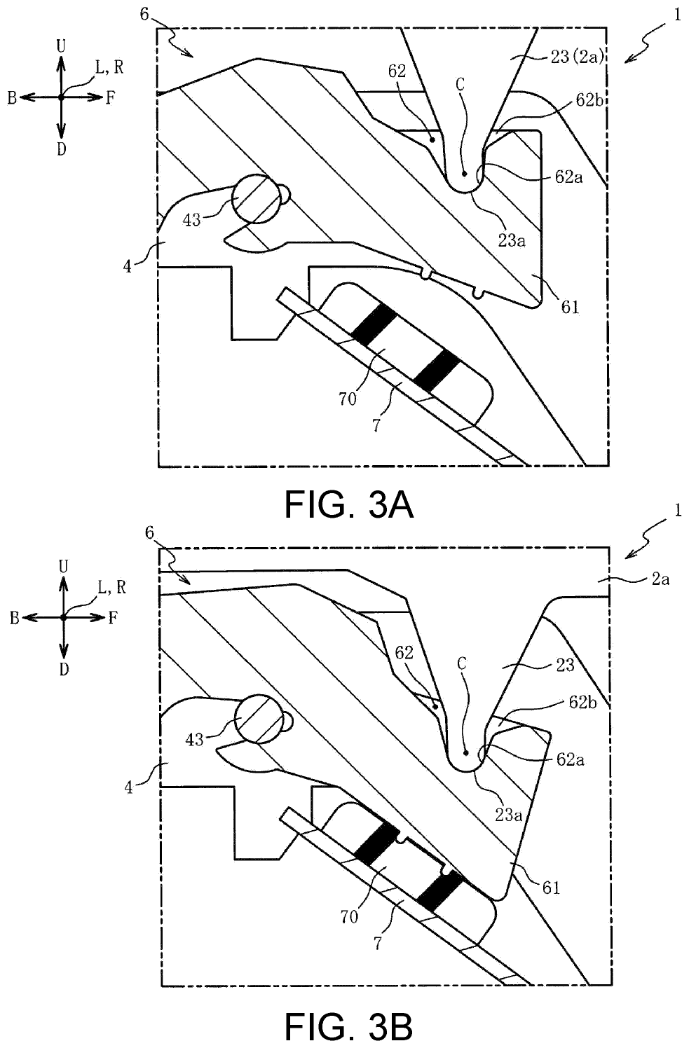

FIG. 1 illustrates a state in which a portion of a chassis 4 is cut away to expose a receiving part 62 of a hammer 6. FIG. 2 illustrates a cross section cut along a plane orthogonal to a scale direction (direction in which a plurality of keys 2 are arranged side by side). Arrows U-D, F-B, and L-R in FIG. 1 and FIG. 2 indicate the up-down direction, the front-rear direction, and the scale direction of the keyboard device 1, respectively, and the same applies to FIG. 3A and FIG. 3B and the subsequent drawings.

As shown in FIG. 1 and FIG. 2, the keyboard device 1 is a keyboard instrument (electronic piano) including a plurality of (88 in the present embodiment) keys 2. The keys 2 include a plurality of (52 in the present embodiment) white keys 2a for playing natural tones, and a plurality of (36 in the present embodiment) black keys 2b for playing derived tones. The plurality of white keys 2a and black keys 2b are arranged side by side in the scale direction (arrow L-R direction).

The keyboard device 1 includes a keybed 3 for supporting the white key 2a and the black key 2b. The keybed 3 is formed in a flat plate shape extending in the scale direction using synthetic resin or a steel plate or the like. The chassis 4 that is made of resin is supported on an upper surface of the keybed 3. Both front and rear ends of the chassis 4 are fixed to the keybed 3 via a channel member 5.

A support structure of the white key 2a with respect to the chassis 4 and a detailed configuration of the white key 2a are described below. However, such configurations are substantially the same in the black key 2b. A wall part 40 rises upward from an upper surface on a rear end side (arrow B side) of the chassis 4. A shaft part 41 of a substantially columnar shape is formed on an upper end side of the wall part 40. The wall part 40 and the shaft part 41 are formed integrally with the chassis 4. However, the wall part 40 and shaft part 41 May be formed separately from the chassis 4.

A plurality of wall parts 40 are arranged side by side in the scale direction (see FIG. 1). A protruding portion 20 of the white key 2a is inserted into a space between the plurality of wall parts 40 facing each other. In the following description, a pair of wall parts 40 (shaft parts 41) facing each other with the protruding portion 20 in between are simply referred to as “a pair of wall parts 40 (shaft parts 41)”.

The protruding portion 20 protrudes rearward from a rear end of the white key 2a. A guiding groove 21 is formed on each of a pair of side surfaces (left and right surfaces facing the scale direction) of the protruding portion 20. The guiding groove 21 is formed in a curved shape convex toward the rear side (arrow B side). The shaft part 41 formed on inner surfaces (surfaces where the pair of wall parts 40 face each other) of the pair of wall parts 40 is fitted into the guiding groove 21.

When the shaft part 41 is fitted into the guiding groove 21, the protruding portion 20 of the white key 2a is inserted between the pair of shaft parts 41 from above. This insertion is guided by an inclined plane 22 (see FIG. 1) of the protruding portion 20 and an inclined plane 42 (see the enlarged portion in FIG. 1) of the shaft part 41. The inclined plane 22 is inclined so that lower ends of the pair of side surfaces of the protruding portion 20 are obliquely notched. An upper edge of the inclined plane 22 is connected to a lower end of the guiding groove 21.

The inclined plane 42 of the shaft part 41 is inclined so that an upper end of a tip surface of the shaft part 41 is obliquely notched. By inserting the protruding portion 20 of the white key 2a from above into a space between the pair of shaft parts 41 facing each other, the inclined plane 22 of the protruding portion 20 and the inclined plane 42 of the shaft part 41 slide against each other. Due to this sliding, the wall part 40 of a plate shape is elastically deformed and a distance between the pair of shaft parts 41 facing each other is increased, thereby making it possible to easily fit the shaft part 41 into the guiding groove 21.

By fitting the shaft part 41 into the guiding groove 21, the white key 2a is slidably (swingably) supported in the space between the pair of wall parts 40 facing each other. When the white key 2a is depressed, the sliding of the guiding groove 21 against the shaft part 41 causes a portion on a rear end side of the white key 2a to swing so as to sink downward. The hammer 6 that is interlocked with this swinging is provided below the white key 2a.

A rotation shaft 43 (see FIG. 2) is formed with its axis oriented in the scale direction in a substantially central portion of the chassis 4 in the front-rear direction. The hammer 6 is rotatably supported by the rotation shaft 43. The hammer 6 includes a mass part 60 (mass body) for giving a feeling of key depression when the white key 2a is depressed. The mass part 60 is located on the rear side (arrow B side) of the rotation shaft 43.

A portion of the hammer 6 on the front side (arrow F side) of the rotation shaft 43 is configured as a pressing part 61 for pushing a switch 70 of a substrate 7 when the white key 2a is depressed. On an upper surface of the pressing part 61, a receiving part 62 recessed downward is formed. A protrusion 23 inserted into the receiving part 62 protrudes downward from a lower surface of the white key 2a.

Since the protrusion 23 is simply inserted into (mounted on) the receiving part 62, when the white key 2a is assembled, after the protrusion 23 is mounted on the receiving part 62, as described above, it is sufficient to insert the protruding portion 20 into the space between the wall parts 40 facing each other and fit the shaft part 41 into the guiding groove 21. Thus, the work of assembling the white key 2a to the chassis 4 can be easily performed.

On the other hand, when the white key 2a is removed from the chassis 4, after the wall part 40 is elastically deformed (the wall part 40 is pushed and extended) and the shaft part 41 is removed from the guiding groove 21, it is sufficient to pull out the protrusion 23 from the receiving part 62. Thus, the work of removing the white key 2a can also be easily performed, and thus, maintainability of the white key 2a can be improved.

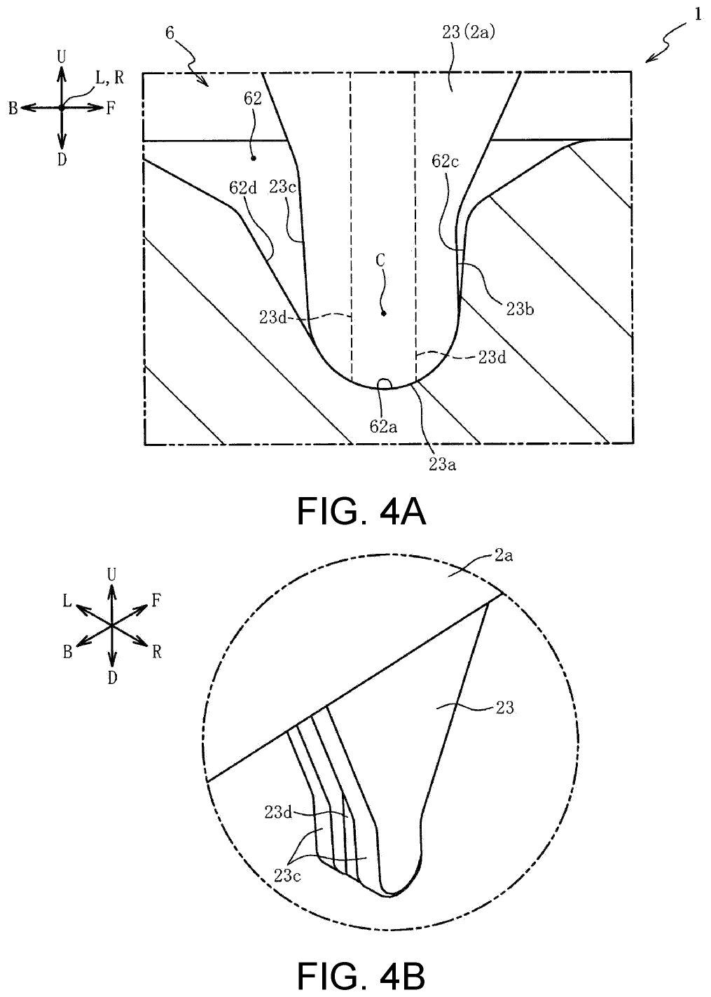

Next, a detailed configuration of the keyboard device 1 is described with reference to FIG. 3A and FIG. 3B. FIG. 3A is a partially enlarged cross-sectional view of the keyboard device 1 in portion IIIa of FIG. 2; FIG. 3B is a partially enlarged cross-sectional view of the keyboard device 1, showing a state in which the white key 2a is depressed from the state shown in FIG. 3A. In FIG. 3A and FIG. 3B, the hatching of the white key 2a is omitted to simplify the drawings, and the same applies to the cross-sectional views of the keyboard device 1 in FIG. 4A and FIG. 4B and the subsequent drawings.

As shown in FIG. 3A and FIG. 3B, a lower surface 23a of the protrusion 23 of the white key 2a is formed in an arc shape convex downward. Likewise, a bottom surface 62a of the receiving part 62 of the hammer 6 is formed in an arc shape convex downward. The lower surface 23a of the protrusion 23 and the bottom surface 62a of the receiving part 62 have the same curvature. In an initial state (hereinafter referred to as “initial position before key depression”) before the white key 2a is depressed, the lower surface 23a and the bottom surface 62a are in surface contact.

When the white key 2a is depressed from the initial position, since the pressing part 61 (receiving part 62) is pushed downward by the protrusion 23 of the white key 2a, the hammer 6 rotates about the rotation shaft 43 (clockwise in FIG. 3A and FIG. 3B) (see FIG. 3B).

As the hammer 6 rotates about the rotation shaft 43, the lower surface 23a of the protrusion 23 slides along the bottom surface 62a of the receiving part 62. During this sliding, the protrusion 23 rotates about a center C (hereinafter referred to as “rotation center C”) of a circle including the arc-shaped bottom surface 62a (arc surface) of the receiving part 62. Accordingly, compared to the case where the protrusion slides back and forth with respect to the receiving part as in, for example, the technology of Japanese Patent Laid-Open No. 2022-070658 (Patent Document 2), the situation that a lubricant (such as grease) applied to the receiving part 62 is pushed aside back and forth due to displacement of the protrusion 23 can be suppressed.

Since the lubricant applied to an engagement portion between the white key 2a and the hammer 6 can be held by the receiving part 62, the flowing down of the lubricant as in, for example, the technology of WO2021/124477 (Patent Document 1), can be suppressed. Thus, since an increase in sliding resistance of the protrusion 23 in the receiving part 62 can be suppressed, a player can be given a good feeling of key depression.

Since the substrate 7 (switch 70) is provided below the pressing part 61 of the hammer 6, as the hammer 6 rotates when the white key 2a is depressed, the switch 70 is pushed by the pressing part 61. By on/off of the switch 70, key depression information (note information) of the white key 2a is detected, and a musical tone signal is output to the outside based on this detection result.

As described above, since the lubricant applied to the engagement portion between the white key 2a and the hammer 6 is held by the receiving part 62, the lubricant can be prevented from adhering to the substrate 7 or the switch 70 located below the receiving part 62. Thus, the substrate 7 or the switch 70 can be prevented from malfunctioning.

The receiving part 62 includes a wall 62b rising from the bottom surface 62a. Since a pair of walls 62b are formed at both ends of the bottom surface 62a of the receiving part 62 in the scale direction (arrow L-R direction) (see FIG. 1 for the point that the wall 62b is formed in pairs), the lubricant applied to the receiving part 62 can be relatively reliably prevented from flowing down. Thus, an increase in sliding resistance of the protrusion 23 in the receiving part 62 or adhering of the lubricant to other members located below the receiving part 62 can be suppressed.

In this way, the present embodiment has a structure in which the white key 2a and the hammer 6 are rotatably engaged (the protrusion 23 is rotated about the rotation center C). In such a structure, it is necessary to slidably engage (support) either of the white key 2a and the hammer 6 with respect to the chassis 4. A reason is that, in a structure in which all engagement portions (engagement portions in three places) between three parts (the chassis 4, the white key 2a, and the hammer 6) are rotatably engaged, the white key 2a and the hammer 6 become unable to rotate.

That is, in the case of a structure in which the white key 2a and the hammer 6 are rotatably engaged as in the present embodiment, for example, it is also possible to slidably support (engage) the hammer 6 with respect to the chassis 4. Examples of a structure in which the hammer 6 is slid with respect to the chassis 4 include a technology of Japanese Patent Laid-Open No. H07-181959. However, in a configuration in which the hammer 6 is slid with respect to the chassis 4, the switch 70 cannot be appropriately pushed by the hammer 6.

In contrast, in the present embodiment, while the shaft part 41 (see FIG. 2) of the chassis 4 and the guiding groove 21 (see FIG. 2) of the white key 2a are slidably engaged, the hammer 6 is rotatably engaged with the rotation shaft 43 of the chassis 4. With such a configuration, compared to the case where the hammer 6 is slid with respect to the chassis 4, the switch 70 can be appropriately pushed by the hammer 6. Thus, key depression information can be detected with high accuracy.

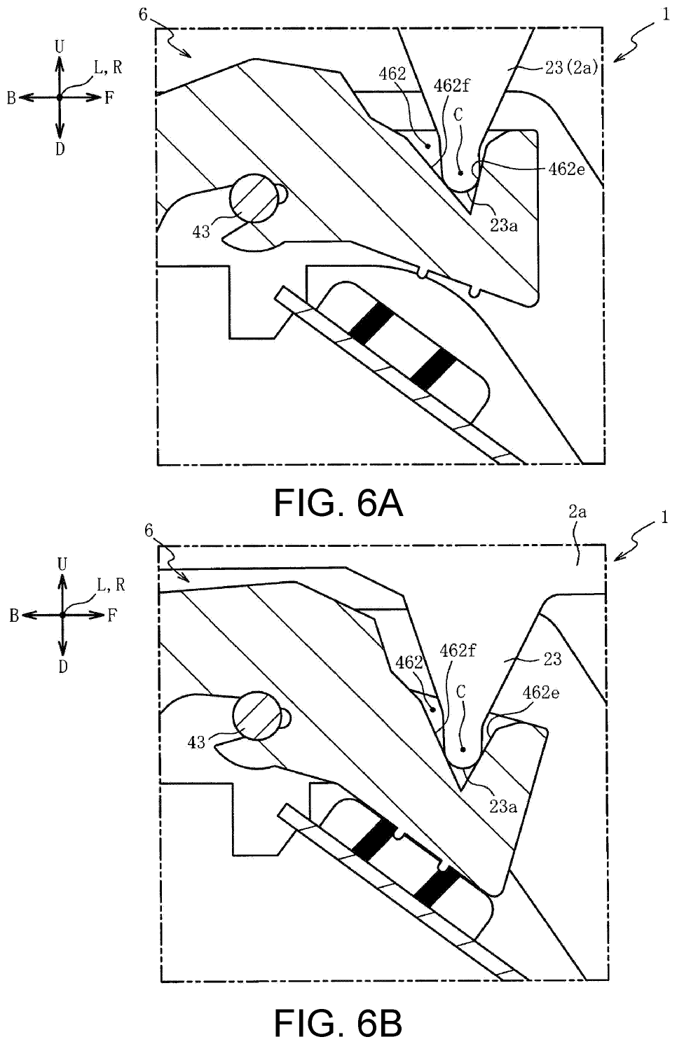

Although not illustrated, since the shaft part 41 (see FIG. 2) of the chassis 4 and the guiding groove 21 (see FIG. 2) of the white key 2a are slidably engaged, the portion on the rear end of the white key 2a is displaced so as to sink downward at the time of key depression. This sliding displacement of the shaft part 41 along the guiding groove 21 is the same motion as, for example, the sliding displacement of a guiding groove 314 along a guide pin 361 shown in FIG. 6 of WO2021/124477.

That is, when the white key 2a is depressed, due to the sliding of the guiding groove 21 along the shaft part 41 and the rotation of the protrusion 23 about the rotation shaft 43, the entire white key 2a is displaced to sink. Accordingly, the white key 2a can be displaced in a displacement trajectory close to that of a key of an acoustic piano.

Next, the configuration of the keyboard device 1 is further described with reference to FIG. 4A and FIG. 4B, and also with reference to FIG. 2, FIG. 3A and FIG. 3B as necessary. FIG. 4A is a partially enlarged cross-sectional view of the keyboard device 1, in which the engagement portion between the protrusion 23 of the white key 2a and the receiving part 62 of the hammer 6 is enlarged; FIG. 4B is a partially enlarged perspective view of the white key 2a, in which portion IVb of FIG. 1 is enlarged. FIG. 4A illustrates the initial position (the state shown in FIG. 3A) before key depression. In FIG. 4A, a bottom surface of a recess 23d of a groove shape shown in FIG. 4B is illustrated in broken lines.

As shown in FIG. 4A and FIG. 4B, a front surface 23b of the protrusion 23 is connected to a front edge (edge on the arrow F side) of the arc-shaped lower surface 23a of the protrusion 23, and a rear surface 23c of the protrusion 23 is connected to a rear edge (edge on the arrow B side) of the lower surface 23a. Each of the front surface 23b and the rear surface 23c of the protrusion 23 is a plane extending in the up-down direction.

A first facing surface 62c, which faces the front surface 23b of the protrusion 23, is connected to a front edge (edge on the arrow F side) of the bottom surface 62a of the receiving part 62. A second facing surface 62d, which faces the rear surface 23c of the protrusion 23, is connected to a rear edge (edge on the arrow B side) of the bottom surface 62a.

The first facing surface 62c is a plane rising and inclined forward in the initial position before key depression. The second facing surface 62d is a plane rising and inclined rearward in the initial position before key depression. The first facing surface 62c is relatively displaced in a direction away from the protrusion 23 at the time of key depression (see FIG. 3A and FIG. 3B), The second facing surface 62d is relatively displaced in a direction approaching the protrusion 23 at the time of key depression (see FIG. 3A and FIG. 3B).

Here, as described above, since the guiding groove 21 (see FIG. 2) of the white key 2a is slidably engaged with the shaft part 41 (see FIG. 2) of the chassis 4, when the white key 2a swings due to key depression or key release, there is a possibility that the white key 2a may rattle in the front-rear direction. Hence, it is preferable that a gap between the protrusion 23 (front surface 23b and rear surface 23c) and each of the facing surfaces 62c and 62d of the receiving part 62 is relatively narrow. By narrowing this gap, rattling of the white key 2a in the front-rear direction is less likely to occur.

On the other hand, in order to allow rotation of the protrusion 23 in the receiving part 62 from the initial position before key depression to an end position of key depression, it is necessary to provide a gap to the extent that the protrusion 23 and each of the facing surfaces 62c and 62d do not contact each other. That is, the gap between the front surface 23b and the rear surface 23c of the protrusion 23 and each of the facing surfaces 62c and 62d of the receiving part 62 is preferably as narrow as possible to the extent that rotation of the protrusion 23 about the rotation center C is allowed.

In contrast, in the present embodiment, in the initial position (the state shown in FIG. 4A) before key depression, the gap between the protrusion 23 (rear surface 23c) and the second facing surface 62d is formed wider than the gap between the protrusion 23 (front surface 23b) and the first facing surface 62c about the rotation center C. Accordingly, while rotation of the protrusion 23 in the receiving part 62 is allowed, the gap between the receiving part 62 and each of the facing surfaces 62c and 62d can be made as narrow as possible. Thus, swinging of the white key 2a due to key depression or key release can be stabilized.

In the initial position before key depression, at least a portion of the first facing surface 62c is separated from the front surface 23b of the protrusion 23. In the end position (the state shown in FIG. 3B) of key depression, at least a portion of the second facing surface 62d is separated from the rear surface 23c of the protrusion 23. Accordingly, when the white key 2a is depressed to the end position, the occurrence of noise caused by contact between the rear surface 23c of the protrusion 23 and the second facing surface 62d can be reduced. When the white key 2a returns to the initial position before key depression, the occurrence of noise caused by contact between the front surface 23b of the protrusion 23 and the first facing surface 62c can be reduced.

As shown in FIG. 4B, the recess 23d that is recessed toward the front side is formed in the rear surface 23c of the protrusion 23. As shown in broken lines in FIG. 4A, the recess 23d that is recessed toward the rear side is formed in the front surface 23b of the protrusion 23. These recesses 23d are formed in a groove shape extending in the up-down direction, and lower ends of the recesses 23d extend to the lower surface 23a (arc surface) of the protrusion 23. Accordingly, with the lubricant applied to the receiving part 62 being held by the recess 23d, the protrusion 23 can be rotated along the bottom surface 62a of the receiving part 62. Thus, an increase in sliding resistance of the protrusion 23 in the receiving part 62 can be effectively suppressed.

In the present embodiment, one recess 23d of a groove shape is formed on each of the front surface 23b side and the rear surface 23c side of the protrusion 23. However, a plurality of recesses 23d may be formed on either (or both) of the front surface 23b and the rear surface 23c of the protrusion 23.

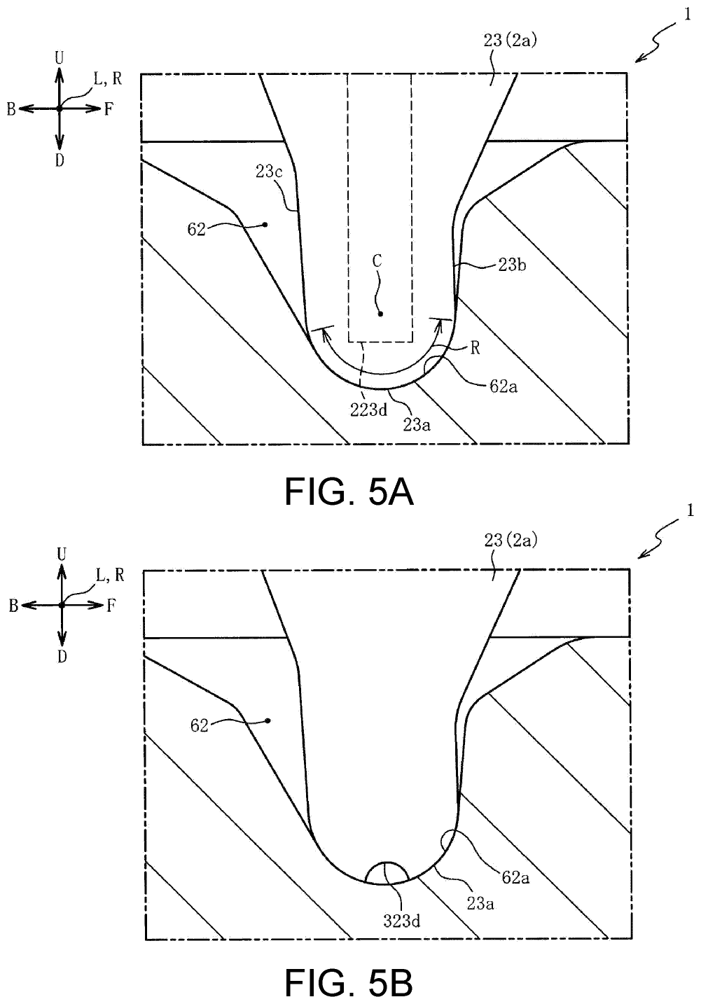

Next, modifications of the keyboard device 1 will be described with reference to FIG. 5A to FIG. 7B. The same reference numerals denote the same portions as those of the keyboard device 1 described above, and descriptions thereof are omitted. First, a modification of the recess 23d is described with reference to FIG. 5A and FIG. 5B. FIG. 5A is a partially enlarged cross-sectional view of the keyboard device 1, showing a recess 223d of a first modification; FIG. 5B is a partially enlarged cross-sectional view of the keyboard device 1, showing a recess 323d of a second modification.

As shown in FIG. 5A, the recess 223d of the first modification is formed by connecting the recess 23d (see FIG. 4A) on the front surface 23b side of the protrusion 23 and the recess 23d (see FIG. 4A) on the rear surface 23c side in the front-rear direction.

More specifically, if a range in which the lower surface 23a of the protrusion 23 slides against the bottom surface 62a of the receiving part 62 from the initial position before key depression to the end position of key depression is set as a sliding range R, the recess 223d is continuously formed from a front end to a rear end of the sliding range R. That is, the recess 223d is formed in a groove shape extending in a rotation direction of the protrusion 23 about the rotation center C. Accordingly, as the protrusion 23 rotates at the time of key depression (release), a lubricant held by the recess 223d is easily supplied to the entire sliding range R. Thus, an increase in sliding resistance of the protrusion 23 in the receiving part 62 can be effectively suppressed.

In this modification as well, the recess 223d is formed in one place in the center of the protrusion 23 in the scale direction (arrow L-R direction). However, a plurality of recesses 223d may be formed to be arranged side by side in the scale direction.

As shown in FIG. 5B, the recess 323d of the second modification is formed so that a lower end of the lower surface 23a of the protrusion 23 is notched. The recess 323d is a groove extending across both ends of the lower surface 23a of the protrusion 23 in the scale direction (arrow L-R direction). Since a lubricant can be held by the recess 323d like this, an increase in sliding resistance of the protrusion 23 with respect to the receiving part 62 can be suppressed.

The recess 323d is formed in one place in the lower surface 23a of the protrusion 23.

However, a plurality of recesses 323d may be formed to be arranged side by side from the front edge to the rear edge of the lower surface 23a of the protrusion 23. A configuration may be adopted in which the recess 223d of the first modification and the recess 323d of the second modification are combined (for example, a grid-like recess is formed in the lower surface 23a of the protrusion 23).

Next, a modification of the receiving part 62 is described with reference to FIG. 6A and FIG. 6B. FIG. 6A is a partially enlarged cross-sectional view of the keyboard device 1, showing a receiving part 462 of a modification; FIG. 6B is a partially enlarged cross-sectional view of the keyboard device 1, showing a state in which the white key 2a is depressed from the state shown in FIG. 6A.

As shown in FIG. 6A and FIG. 6B, the receiving part 462 of the modification includes: a first inclined plane 462e, contacting the lower surface 23a of the protrusion 23 on the front side (arrow F side) of the protrusion 23; and a second inclined plane 462f, contacting the lower surface 23a of the protrusion 23 on the rear side (arrow B side) of the protrusion 23.

The first inclined plane 462e is a plane rising and inclined toward the front side (arrow F side) in the initial position before key depression. The second inclined plane 462f is a plane rising and inclined toward the rear side (arrow B side) in the initial position before key depression.

In this modification, since lower ends of the first inclined plane 462e and the second inclined plane 462f intersect each other, the receiving part 462 is formed in a V shape in cross section. However, the receiving part 462 may be formed in a trapezoidal shape or a substantially U shape in cross section by formation of a connecting surface (a plane or a curved surface that does not contact the lower surface 23a of the protrusion 23) that connects the lower ends of each of the inclined planes 462e and 462f in the front-rear direction.

Since the arc-shaped lower surface 23a of the protrusion 23 is supported by the first inclined plane 462e and the second inclined plane 462f, when the hammer 6 rotates about the rotation shaft 43 as the white key 2a is depressed, the lower surface 23a of the protrusion 23 slides along each of the inclined planes 462e and 462f of the receiving part 462. During this sliding, the protrusion 23 rotates about the rotation center C (the center of a circle including the arc-shaped lower surface 23a of the protrusion 23). Thus, compared to the case where the protrusion is slid back and forth with respect to the receiving part as in the related art, a situation that a lubricant applied to the receiving part 462 is pushed aside back and forth can be suppressed. The lubricant applied to the engagement portion between the white key 2a and the hammer 6 can be held by the receiving part 462. Thus, an increase in sliding resistance of the protrusion 23 in the receiving part 462 can be suppressed.

Since the lower surface 23a of the protrusion 23 is supported at two points by the first inclined plane 462e and the second inclined plane 462f, compared to the case where the arc surfaces of the protrusion 23 and the receiving part 62 are brought into surface contact with each other as in the above embodiment, contact area between the protrusion 23 and a bottom surface of the receiving part 462 can be reduced. Thus, the sliding resistance of the protrusion 23 in the receiving part 462 can be reduced.

In the initial position (the state shown in FIG. 6A) before key depression, a gap between the protrusion 23 and the second inclined plane 462f is formed wider than a gap between the protrusion 23 and the first inclined plane 462e about the rotation center C. Accordingly, while rotation of the protrusion 23 in the receiving part 462 is allowed, the gap between the protrusion 23 and each of the inclined planes 462e and 462f can be made as narrow as possible. Thus, swinging of the white key 2a due to key depression or key release can be stabilized.

The recess 23d (see FIG. 4A and FIG. 4B), which is not illustrated, is formed in the protrusion 23, and the recesses 223d and 323d (see FIG. 5A and FIG. 5B) of the above modifications may also be formed in the protrusion 23.

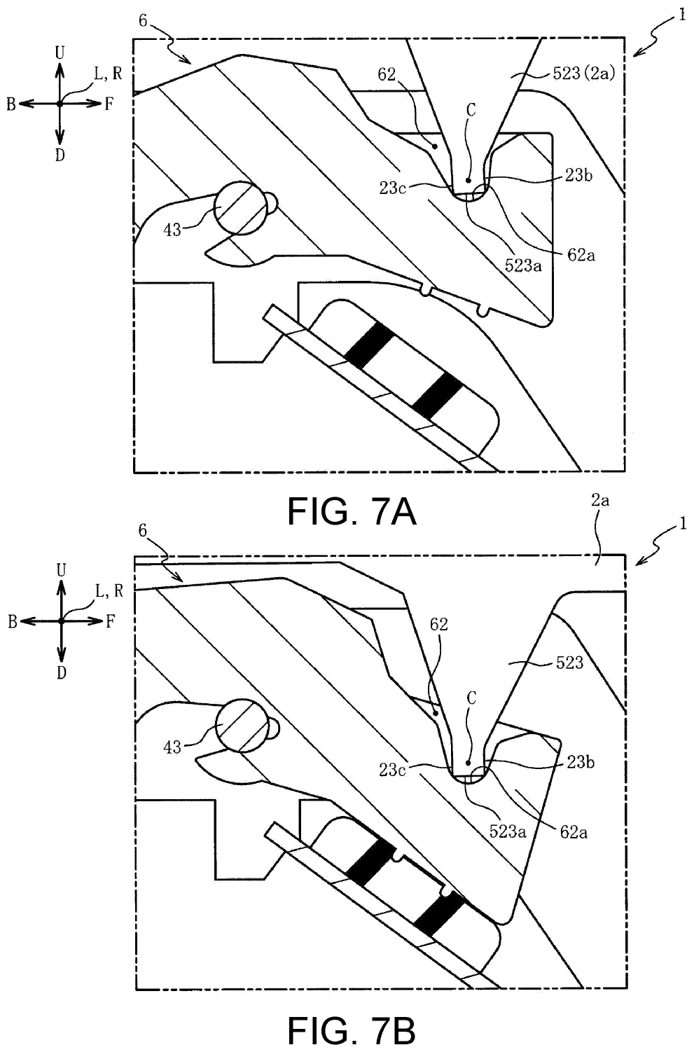

Next, a modification of the protrusion 23 is described with reference to FIG. 7A and FIG. 7B. FIG. 7A is a partially enlarged cross-sectional view of the keyboard device 1, showing a protrusion 523 of a modification; FIG. 7B is a partially enlarged cross-sectional view of the keyboard device 1, showing a state in which the white key 2a is depressed from the state shown in FIG. 7A.

As shown in FIG. 7A and FIG. 7B, a lower surface 523a of the protrusion 523 is a plane that connects the front surface 23b and the rear surface 23c of the protrusion 523 in the front-rear direction (arrow F-B direction). A front edge and a rear edge (connection points with the front surface 23b and the rear surface 23c) of the lower surface 523a of the protrusion 523 are in contact with the arc-shaped bottom surface 62a of the receiving part 62 in the initial position before key depression.

Accordingly, when the hammer 6 rotates about the rotation shaft 43 as the white key 2a is depressed, the lower surface 523a of the protrusion 523 slides along the bottom surface 62a of the receiving part 62. During this sliding, the protrusion 523 rotates about the rotation center

C. Thus, compared to the case where the protrusion is slid back and forth with respect to the receiving part as in the related art, the situation that the lubricant applied to the receiving part 62 is pushed aside back and forth can be suppressed. The lubricant applied to the engagement portion between the white key 2a and the hammer 6 can be held by the receiving part 62. Thus, an increase in sliding resistance of the protrusion 523 in the receiving part 62 can be suppressed.

Since a front edge and a rear edge of the lower surface 523a of the protrusion 523 contact the bottom surface 62a of the receiving part 62 at two points, compared to the case where the arc surfaces of the protrusion 23 and the receiving part 62 are brought into surface contact with each other as in the above embodiment, contact area between the protrusion 523 and the bottom surface 62a of the receiving part 62 can be reduced. Thus, sliding resistance of the protrusion 523 in the receiving part 62 can be reduced.

In this modification as well, it is possible to form the recesses 23d, 223d, and 323d described above (shown in FIG. 4A to FIG. 4B and FIG. 5A to FIG. 5B) in the protrusion 523.

The disclosure has been described above on the basis of the embodiments. However, it is easily understood that the disclosure is not limited to any of the above embodiments, and various modifications or alterations may be made without departing from the spirit of the disclosure.

In the above embodiment, the case has been described where the guiding groove 21 of the white key 2a is slidably engaged with the shaft part 41 of the chassis 4, while the hammer 6 is rotatably (non-slidably) engaged with the rotation shaft 43 of the chassis 4. However, the disclosure is not limited thereto. For example, a configuration may be adopted in which the white key 2a (key 2) is engaged with the chassis 4 to be rotatable (non-slidable) about an axis while the hammer 6 is slidably engaged with the chassis 4.

As described above, examples of the structure in which the hammer 6 is slid with respect to the chassis 4 include the structure of Japanese Patent Laid-Open No. H07-181959. However, the hammer 6 May be slid with respect to the chassis 4 by a configuration corresponding to the guiding groove 21 and the shaft part 41 of the above embodiment.

In the above embodiment, the case has been described where a pair of walls 62b are formed on both end sides of the receiving part 62 (or 462) in the scale direction. However, either or both of the pair of walls 62b may be omitted.

In the above embodiment, the case has been described where, in the initial position before key depression, the gap between the rear surface 23c of the protrusion 23 and the second facing surface 62d (second inclined plane 462f) is formed wider than the gap between the front surface 23b of the protrusion 23 and the first facing surface 62c (first inclined plane 462e) about the rotation center C. However, the disclosure is not limited thereto. For example, the gap between the rear surface 23c of the protrusion 23 and the second facing surface 62d (second inclined plane 462f) may be narrower than the gap between the front surface 23b of the protrusion 23 and the first facing surface 62c (first inclined plane 462e), or these gaps may be of the same size.

In the above embodiment, the case has been described where, in the initial position before key depression, at least a portion of the first facing surface 62c is configured to be separated from the front surface 23b of the protrusion 23, and in the end position of key depression, at least a portion of the second facing surface 62d is configured to be separated from the rear surface 23c of the protrusion 23. However, the disclosure is not limited thereto. For example, in the initial position or the end position, either (or both) of the first facing surface 62c and the second facing surface 62d may be configured to entirely contact the front surface 23b or the rear surface 23c of the protrusion 23.

In the above embodiment, the case has been described where the recess 23d (or 223d or 323d) is formed in the lower surface 23a of the protrusion 23. However, the recess 23d (or 223d or 323d) may be omitted. In the bottom surface 62a (arc surface) of the receiving part 62 or the first inclined plane 462e and the second inclined plane 462f of the receiving part 462, a recess extending in the front-rear direction or the scale direction (or a grid-like recess extending in both directions) may be formed. A configuration may be adopted in which a plurality of recesses (holes not of a groove shape) are scattered in each of the lower surface 23a of the protrusion 23, the lower surface 523a of the protrusion 523, the bottom surface 62a of the receiving part 62, and the first inclined plane 462e and the second inclined plane 462f of the receiving part 462.

In the above embodiment, as an example of the configuration in which the protrusion 23 (or 523) and the receiving part 62 (or 462) are brought into contact at two points, the configuration in which the first inclined plane 462e and the second inclined plane 462f of a planar shape are formed in the receiving part 462, or the configuration in which the lower surface 523a of the protrusion 523 is formed in a planar shape, is illustrated. However, the disclosure is not limited thereto.

For example, the first inclined plane 462e and the second inclined plane 462f of the receiving part 462 or the lower surface 523a of the protrusion 523 may be formed in an arc shape. In this case, by causing the first inclined plane 462e and the second inclined plane 462f of the receiving part 462 to have a smaller curvature than that of the lower surface 23a of the protrusion 23, or by causing the lower surface 523a of the protrusion 523 to have a smaller curvature than that of the bottom surface 62a of the receiving part 62, the protrusion 23 (or 523) and the receiving part 62 (or 462) can be brought into contact at two points.

A configuration may be adopted in which the protrusion 23 (or 523) and the receiving part 62 (or 462) are brought into contact at three or more points. As an example of the configuration in which contact occurs at three points, a configuration in which a plane (or curved surface) connecting the first inclined plane 462e and the second inclined plane 462f of the receiving part 46 in the front-rear direction is brought into contact with the lower surface 23a of the protrusion 23, or a configuration in which the lower surface 523a of the protrusion 523 is formed in a downwardly convex V shape in side view (the lower end of the V-shaped lower surface 523a is brought into contact with the bottom surface 62a of the receiving part 62), is illustrated.

What is claimed is:

1. A keyboard device comprising:
a support member;
a plurality of keys, swingably supported by the support member and arranged side by side in a scale direction; and
a hammer, interlocked with swinging of each of the plurality of keys, wherein
the hammer comprises a receiving part that is recessed downward;
each of the plurality of keys comprises a protrusion that protrudes downward and is inserted into the receiving part;
an arc surface is formed on at least one of a bottom surface of the receiving part and a lower surface of the protrusion; and
in response to swinging of each of the plurality of keys, the protrusion rotates about a center of a circle comprising the arc surface.

2. The keyboard device according to claim 1, wherein
the receiving part comprises a wall rising from both ends of the bottom surface of the receiving part in the scale direction.

3. The keyboard device according to claim 1, wherein
the arc surface is formed on either of the bottom surface of the receiving part and the lower surface of the protrusion, and the other of the bottom surface of the receiving part and the lower surface of the protrusion contacts the arc surface at least two points.

4. The keyboard device according to claim 1, wherein
a first facing surface and a second facing surface facing front and rear of the protrusion are formed on the bottom surface of the receiving part;
the first facing surface is relatively displaced in a direction away from the protrusion in response to depression of each of the plurality of keys;
the second facing surface is relatively displaced in a direction approaching the protrusion in response to depression of each of the plurality of keys; and
in an initial position before key depression of each of the plurality of keys, a gap between the protrusion and the second facing surface is formed wider than a gap between the protrusion and the first facing surface.

5. The keyboard device according to claim 4, wherein
in the initial position, at least a portion of the first facing surface is separated from the protrusion; and
in an end position of key depression of each of the plurality of keys, at least a portion of the second facing surface is separated from the protrusion.

6. The keyboard device according to claim 1, wherein
a recess is formed in the arc surface.

7. The keyboard device according to claim 1, wherein
a recess is formed in the lower surface of the protrusion.

8. The keyboard device according to claim 1, wherein
the arc surface is formed on each of the bottom surface of the receiving part and the lower surface of the protrusion; and
a recess is formed in the arc surface of the protrusion.

9. The keyboard device according to claim 8, wherein
the recess is a groove extending across both front and rear ends of the arc surface of the protrusion.

10. The keyboard device according to claim 8, wherein
the recess is a groove extending across both ends of the arc surface of the protrusion in the scale direction.

11. An interlocking method of a hammer, adapted for a keyboard device comprising a support member, a plurality of keys that are swingably supported by the support member and are arranged side by side in a scale direction, and a hammer that is interlocked with swinging of each of the plurality of keys, in which the hammer comprises a receiving part that is recessed downward, each of the plurality of keys comprises a protrusion that protrudes downward and is inserted into the receiving part, and an arc surface is formed on at least one of a bottom surface of the receiving part and a lower surface of the protrusion, the interlocking method of a hammer comprising:
by rotating the protrusion about a center of a circle comprising the arc surface, interlocking the hammer with swinging of each of the plurality of keys.
